(19) United States
(12) Patent Application Publication
(10) Pub. No.: US 2016/0349939 A1
(43) Pub. Date: Dec. 1, 2016

(54) SYSTEM AND METHOD FOR PROVIDING AN IMAGE FOR DISPLAY

(71) Applicant: Google Inc., Mountain View, CA (US)

(72) Inventors: Matthew Robert SIMPSON, San Francisco, CA (US); Jonah Jones, San Francisco, CA (US)

(21) Appl. No.: 13/766,711

(22) Filed: Feb. 13, 2013

(51) Int. Cl. G06F 3/0482

(52) U.S. Cl. CPC G06F 3/0482

(57) ABSTRACT

A system and method for providing an image for display are provided. An indication of a selected area on a map, where the map is displayed in a user interface at a zoom level is received. A geographical range corresponding to a region on the map that includes the selected area is determined. One or more images associated with the region corresponding to the geographical range are identified. An image from the one or more identified images is selected for display in the user interface.

### FIELD

The subject technology generally relates to providing visual content for display, and in particular, relates to providing for display, an image that is associated with an area in a map.

### BACKGROUND

Many map zoom technologies can zoom-in from a designated area that corresponds to a geographical area to provide an image that is associated with a geographical location that is within the geographical area. However, a zoom-in from a designated area that corresponds to a large geographical area sometimes produces an image that is associated with a geographical location that is of little interest, and a zoom-in from a designated area that corresponds to a small geographical area sometimes produces an image that does not have an interesting orientation.

### SUMMARY

The disclosed subject matter relates to a computer-implemented method for providing an image for display. The method comprises receiving an indication of a selected area on a map displayed in a user interface. The method further comprises determining, based the selected area and a zoom level of the map, a geographical range corresponding to a region on the map that includes the selected area. The method further comprises identifying one or more images associated with the region corresponding to the geographical range. The method further comprises selecting an image from the one or more identified images for display in the user interface.

The disclosed subject technology further relates to a system for providing an image for display. The system includes one or more processors, and a machine-readable medium comprising instructions stored therein, which when executed by the processors, cause the processors to perform operations comprising receiving an indication of a selected area on a map displayed in a user interface. The operations further comprise determining, based the selected area and a magnitude of the zoom level of the map, a geographical range corresponding to a region on the map that includes the selected area. The operations further comprise identifying one or more images associated with the region corresponding to the geographical range. The operations further comprise selecting an image from the one or more identified images for display in the user interface.

The disclosed subject matter further relates to a machine readable medium including instructions stored therein, which when executed by a system, cause the system to perform operations comprising receiving an indication of a selected area on a map displayed in a user interface. The operations further comprise determining, based the selected area and a zoom level of the map, a geographical range corresponding to a region on the map that includes the selected area, wherein the geographical range is inversely proportional to the magnitude of the zoom level. The operations further comprise identifying one or more images associated with the region corresponding to the geographical range. The operations further comprise selecting an image from the one or more identified images for display in the user interface.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

It is to be understood that both the foregoing general description and the following detailed description are exemplary and explanatory and are intended to provide further explanation of the subject technology as claimed.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for providing an image for display.

FIG. 2 illustrates an example process for providing an image for display.

FIG. 3A illustrates an example interface that provides a map at a first zoom level.

FIG. 3B illustrates an example interface that provides an image associated with the region of the map of FIG. 3A.

FIG. 3C illustrates an example interface that provides a map at a second zoom level.

FIG. 3D illustrates an example interface that provides an image associated with the region of the map of FIG. 3C.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject technology, a system and a method for providing an image for display are provided. An indication of a selected area on a map, where the map is displayed in a user interface at a zoom level is received. The map may be provided for display, at one or more adjustable zoom levels, which corresponds to providing for display, a geographical range at different geographical distance per pixel ratios. The geographical range corresponds to a region on the map that includes the selected area and is determined based on the selected area and the zoom level of the map.

Sometimes, the selected area may not correspond to the exact user intended geographical location, instead, a geographical location near the user intended geographical location may be selected instead. These problems may arise from a myriad of reasons including the user's failure to precisely select the intended geographical location, failure by the user's electronic device to accurately register the selected geographical location, etc. Therefore, the geographical range may include the selected area and areas surrounding the selected area in order to provide a margin or error to account for possible imprecision.

Images associated with the determined geographical range are then identified. The identified images may include, but are not limited to, user selected canonical images and panoramic images of a particular geographical location within the selected area. In an example aspect where the geographical range includes both the selected area and surrounding areas, the identified images also include images associated with a geographical location within the geographical range that surrounds the selected area. For example, if a city is selected, the determined geographical range may include the city and surrounding suburbs. In this case, images associated with the city and the surrounding suburbs are identified.

The size of surrounding area that is also within the geographical range may be based on the zoom level of the map. For example, if the map is displayed at a high zoom level (e.g., the map corresponds to a city and the selected area corresponds to point of interest in the city), then the surrounding area would have a smaller size relative to the size of the surrounding area if map is displayed at a low zoom level (e.g., the map corresponds to a state, and the selected area corresponds to the city in the previous selection).

In example aspects, selecting an area on a map that is set to a high zoom level includes selecting an orientation of an image taken from the selected area. Selecting an area on a map that is set to a mid-zoom level includes selecting an image of a geographical location within a first distance of the selected area of the map and selecting an orientation of the selected image. Selecting an area of a map that is set to a low zoom level includes selecting an image of a geographical location within a second distance of the selected area of the map, where the second distance is greater than the first distance, and also selecting an orientation of the selected image.

A top-ranked image that is associated with the determined geographical range may be selected. A top-ranked orientation of an image may also be selected. Images and/or image orientations may be ranked based on popularity, prior user preference, etc. A ranking of images that are associated with the determined geographical range may be performed in response to receipt of an indication of the selected area on the map. A ranking of images for various geographical ranges may also be periodically computed, and a most recent ranking for the determined geographical range may be used to determine the top-ranked image that is associated with the determined geographical range. The selected image that is associated with the selected area is then provided for display in the user interface according to the identified selection criterion.

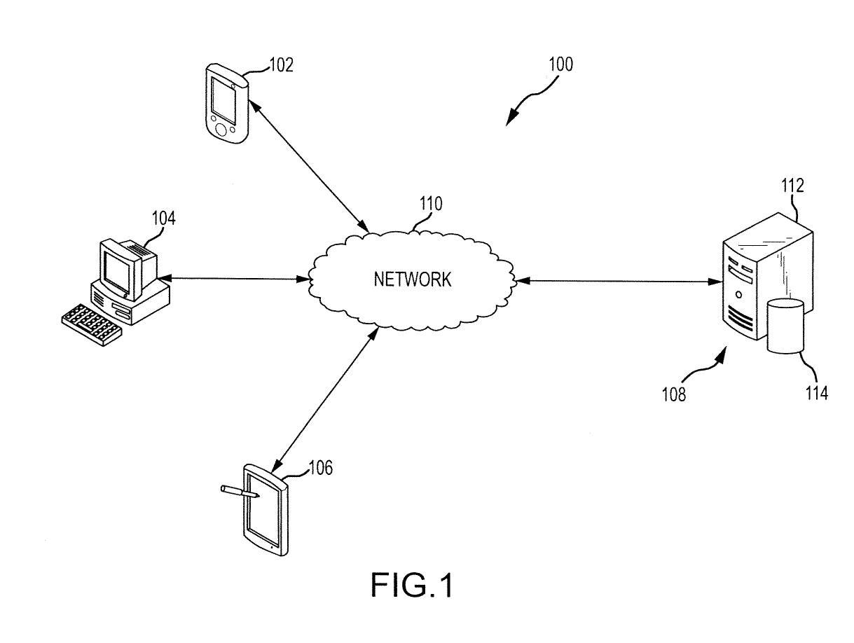

FIG. 1 illustrates an example network environment for providing an image for display. A network environment 100 includes a number of electronic devices 102, 104, and 106 communicably connected to a server 108 by a network 110. Server 108 includes a processing device 112 and a data store 114. Processing device 112 executes computer instructions stored in data store 114, for example, to select an image that is associated with an area of a map.

In example aspects, each of the electronic devices 102, 104, or 106 may include any machine with hardware and software to provide a user interface to display a map. Electronic devices 102, 104, and 106 can be mobile devices (e.g., smartphones, tablet computers, PDAs, and laptop computers), portable media players, desktop computers or other appropriate computing devices. In the example of FIG. 1, electronic device 102 is depicted as a smartphone, electronic device 104 is depicted as a laptop computer, and electronic device 106 is depicted as a tablet computer.

Server 108 may be any system or device having a processor, memory, and communications capability for providing an image for display on electronic device 102, 104, or 106. Server 108 may be a single computing device such as a computer server. Server 108 may also represent more than one computing device working together to perform the actions of a server computer.

Server 108 includes a processing device 112 and a data store 114. Processing device 112 executes computer instructions stored in a computer-readable medium, for example, to providing an image that is associated with an area on a map to electronic devices 102, 104, and 106. Data store 114, contains images that are associated with different areas on a map. Images may include panoramic images, canonical images, and/or other types of images that are associated with an area of the map.

Server 108 receives from electronic device 102, 104, or 106, an indication of a selected area on a map, where the map is displayed in a user interface. The map contains at least one zoom level, where the geographical distance per pixel ratio of the map varies based on the zoom level of the map. Server 108, determines, based on the selected area and the zoom level of the map, a geographical range that corresponds to a region on the map that includes the selected area. The region that corresponds to the determined geographical range may also include areas that surround the selected area. The size of the surrounding areas that are included in the region is based on the zoom level of the map. In one example, the size of the surrounding areas that are included in the region is inversely proportional to the zoom level of the map.

Server 108 identifies images associated with the region corresponding to the geographical range. The identified images include images that are associated with the selected area. The identified images may also include images associated with areas that surround the selected area that are also included in the determined geographical range.

Server then selects an image from the identified images for display in the user interface of electronic device 102, 104, or 106. Server 108 may determine a top-ranked image from the identified images and select the top ranked image for display. Server may also determine a top ranked orientation for the top ranked image based on several criterions. In example aspects, the top-ranked orientation of the image is an orientation that is most often selected by users during a period of time. In other example aspects, the top-ranked orientation of the image is based on prior user preference. Server 108 then provides the selected image for display in the user interface of electronic device 102, 104, or 106.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

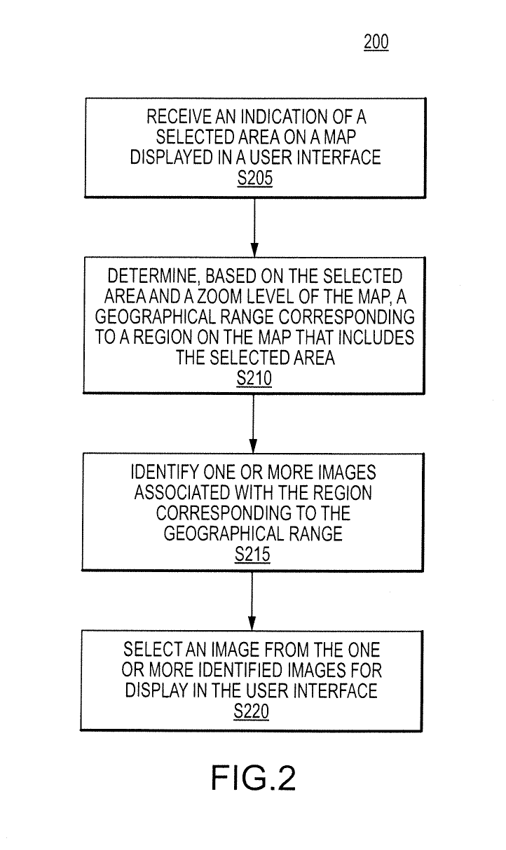

FIG. 2 illustrates an example process for providing an image for display. Although the operations in process 200 are shown in a particular order, certain operations may be performed in different orders or at the same time. In addition, although process 200 is described with reference to the system of FIG. 1, process 200 is not limited to such and can be performed by other system(s).

In block 5205, server 108 receives an indication of a selected area on a map displayed in a user interface. The indication is generated in response to a selection of an area on the displayed map and contains data that is used by server 108 to determine a geographical coordinate and/or coordinate range of the selected area on the map. In block 5210, server 108 determines, based on the selected area and a zoom level of the map, a geographical range corresponding to a region on the map that includes the selected area. According to example aspects, server 108 receives an indication that includes a geographic coordinate and/or coordinate range of the selected area. In this case, the received geographic coordinate and/or coordinate range corresponds to the determined geographical range. According to other example aspects, server 108 receives an indication that includes screen coordinates of the selected area on the displayed map. Server 108, upon receipt of the screen coordinates, determines a geographic coordinate and/or coordinate range that corresponds to the screen coordinates on the displayed map. The determined geographical range may vary based on the zoom level of the map. For example, a geographical range corresponding to a region on a map of a city is smaller than a geographical range corresponding to a region on a map of a country. The geographical range may also be based on a geographical coordinate range. The region that corresponds to the determined geographical range may also include areas surrounding the selected area (e.g., streets bordering a selected point of interest, suburbs that surround a selected city, coastlines that surround a selected island, etc.), where the size of the surrounding areas is based on the zoom level of the map. According to example aspects, the size of the surrounding areas is inversely proportional to the magnitude of the zoom level of the map. According to other example aspects, if the map is displayed at a maximum zoom level, the region that corresponds to the determined graphical range only includes the selected area.

In block 5215, server 108 identifies images (e.g., user selected canonical images, panoramic images, etc.) associated with the region that correspond to the determined geographical range. If the region on the map that corresponds to the determined geographical range also includes areas that surround the selected area, then server 108 also identifies images that are associated with the surrounding areas.

In block 5220, server 108 selects an image from the identified images for display in the user interface. If the region on the map that corresponds to the determined geographical range also includes areas that surround the selected area, then server 108 selects an image from images that are associated with the selected or the surrounding areas.

Server 108 may also rank images that are associated with the determined geographical range to determine a top-ranked image associated with the geographical range. In example aspects, images that are associated with the determined geographical range are ranked based on their popularity. Server 108 may associate popularity of an image with the number of times the image was selected within a temporal period. In other example aspects, images that are associated with the determined geographical range are ranked based on prior user preference. A user may provide server 108 with authorization to maintain the user's personal preferences and/or a history of the user's prior selections of images that are associated with the determined geographical region. Server 108 may rank an image that is associated with the determined geographical range based on the number of times the user has previously selected the image. In other example aspects, server 108 may provide different rankings for an image at different periods of time. In one example, an image of a dormitory housing that houses students may have a higher ranking compared to other images of other points of interests around the dormitory during a school year but have a lower ranking compared to the other images during summer break.

In example aspects, server 108 identifies a selection criterion based on the zoom level. In example aspects, the selection criterion includes selecting a top-ranked image that is associated with the selected area of the map, selecting a top-rank orientation of the top-ranked image that is associated with the selected area of the map, etc.

In example aspects, where the map is at a zoom level that exceeds a first threshold value, the selection criterion corresponds to an orientation of the image taken from the selected area. In one example, the selected orientation of the image is a top-ranked orientation of the image. In other example aspects, where the map is at a zoom level that does not exceed a first threshold value and exceeds a second threshold value, the selection criterion corresponds to the image being associated with the selected area of the map and being a geographical location corresponding to an area within a first distance of the selected area of the map, and where the selection criterion further includes an orientation for the image. In other example aspects, where the map is at a zoom level that does not exceed the first threshold value and does not exceed a second threshold value, the selection criterion corresponds to the image being associated with the selected area of the map and being a geographical location corresponding to an area within a second distance of the selected area of the map, where the second distance is greater than the first distance, and where the selection further includes an orientation for the image. In one example, the selected orientation of the image is a top-ranked orientation of the image. The selected image is then provided to electronic device 102, 104, or 106 via network 110.

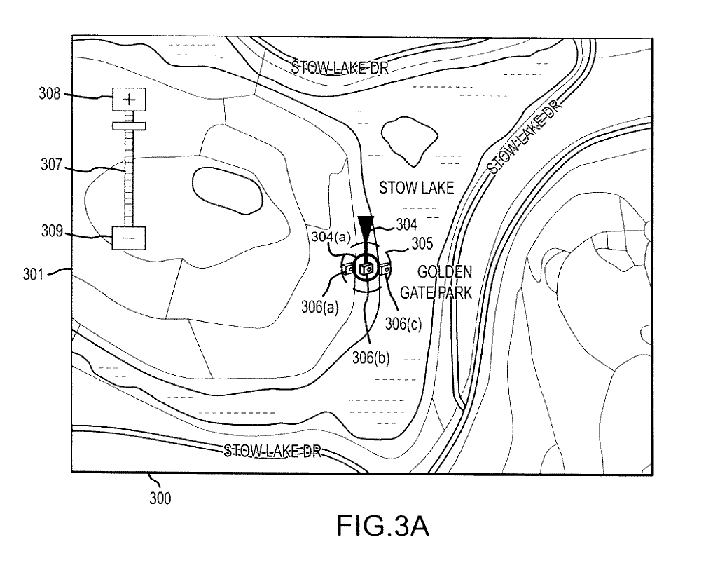

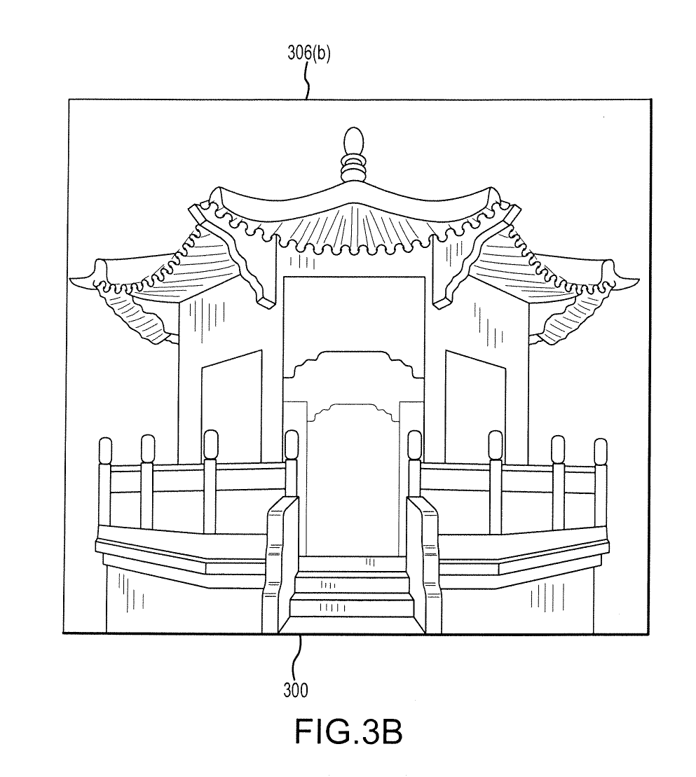

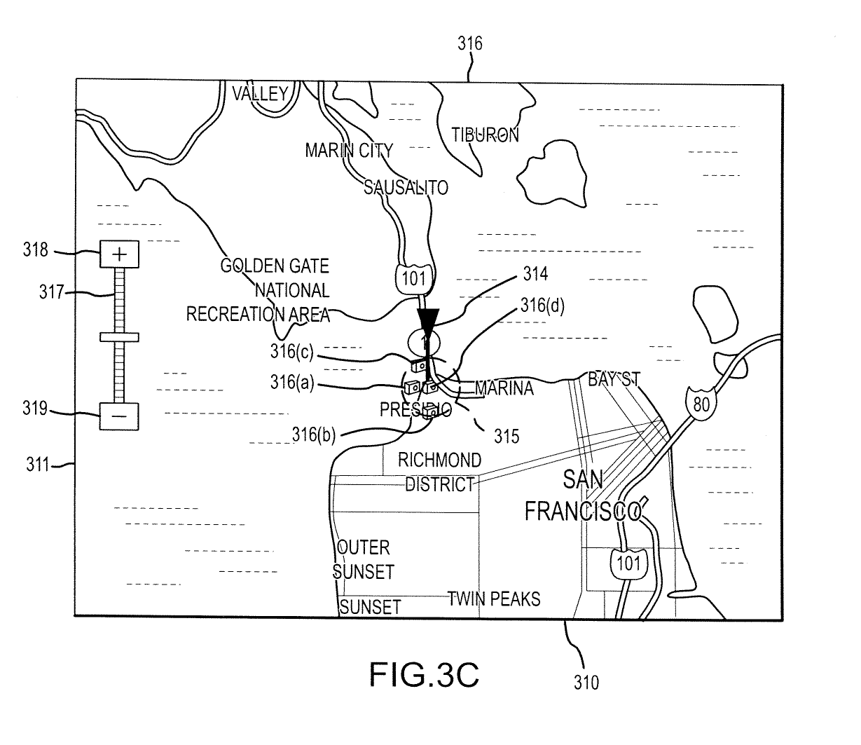

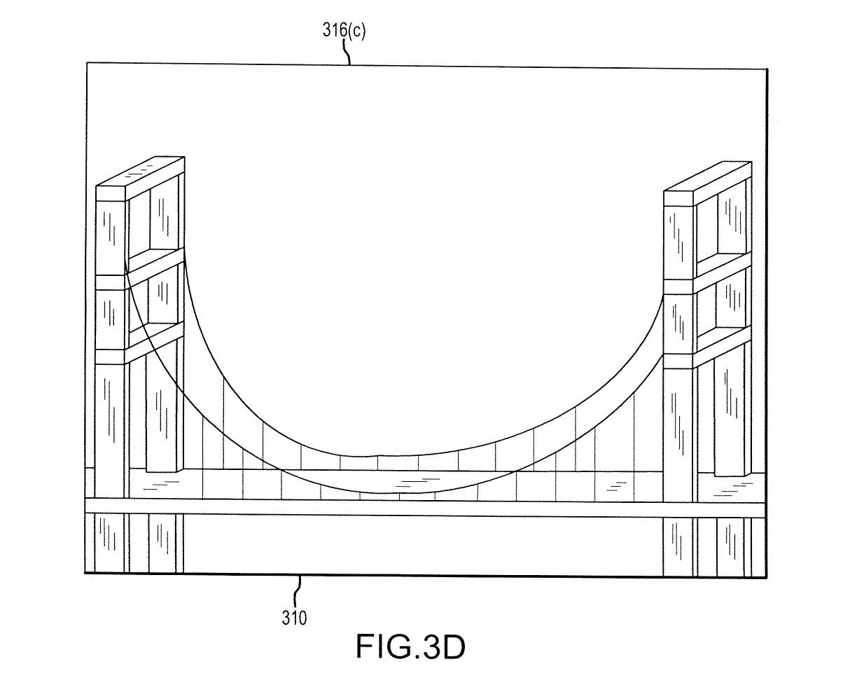

FIG. 3A illustrates an example interface that provides a map at a first zoom level. In the example of FIG. 3A, interface 300 provides a map 301 of a section of the Golden Gate Park. Map 301 contains a zoom indicator 307, which provides a visual indication of the zoom level of the map. The zoom indicator of FIG. 3A may be adjusted to increase or decrease the zoom level of map 301. In example aspects, map 301 is configured to increase in zoom level in response to an indication of a user interaction with plus toggle 308 of the zoom indicator 307 and decrease in zoom level in response to an indication of a user interaction with minus toggle 309 of zoom indicator 307.

As shown in FIG. 3A, icon 304 designates a selected area of map 301. In other example aspects, other zoom indicators that have different visual displays may be used to provide a visual indication of the zoom level of the map. Dashed circle 305 represents a geographical range that corresponds to a region on map 301 that includes the selected area and surrounding areas. In one example, the surrounding areas are included to provide a margin of error to account for impressions when selecting the selected area. Impressions may arise from a myriad of reasons including the user's failure to precisely select the intended geographical location, failure by the user's electronic device to accurately register the selected geographical location, etc. The size of the surrounding areas that are included is based on the zoom level of the map. For example, a map at a street zoom level requires less of a margin of error than a map at a zoom level that shows several cities. In other example aspects, the margin of error may be zero at a maximum zoom level and only the selected area is included in dash circle 305. As shown in FIG. 3A, the determined geographical range is represented by dash circle 305. In other example aspects, the determined geographical range may be represented by different shapes and/or forms (e.g., dashed squares, solid circles, etc.). In other example aspects, an indication of the determined geographical range (e.g., dash circle 305, etc.) is not provided for display on map 301.

Images 306(a), 306(b), and 306(c) are associated with a region on map 301 within dashed circle 305 are then identified. In other example aspects, additional images associated with the region within dashed circle 315 may be identified. As shown in FIG. 3A, icons for the identified images 306(a), 306(b), and 306(c) are provided for display on map 301. In other example aspects, representations of the identified images and/or the dashed circle are not provided for display on map 301. A subsequent selection of the same area at a different zoom level may yield different images. For example, if the magnitude of the zoom level of map 301 is decreased until map 301 provides a map of San Francisco, then a selection of the same area of map 301 may yield additional images that are associated with the selected area and/or surrounding areas of map 301 at the new zoom level.

FIG. 3B illustrates an example interface that provides an image associated with the region of the map of FIG. 3A. In the example of FIG. 3B, an image of the Chinese Pavilion at the Golden Gate Park 306(b) is provided for display on interface 300. In the example of FIG. 3B, image 306(b) is selected from images 306(a), 306(b), and 306(c). In other example aspects, different images may be identified in response to a selection of a different area of map 301 at the current zoom level or selection of the same area of map 301 at a different zoom level.

In example aspects, the selection process includes identifying a top ranked image from the identified images. The identified images may be ranked from any combination of criterions, including, but not limited to prior user preferences, popularity of the identified images, etc. Furthermore, a top-ranked orientation of the top ranked image may also be identified. In example aspects, the top ranked orientation may be based on the most selected orientation of the top ranked image during a temporal period. In other example aspects, the top-ranked orientation may be based on prior user preferences.

FIG. 3C illustrates an example interface that provides a map at a second zoom level. As shown in FIG. 3C, zoom indicator 317, which provides a visual indication of the zoom level of the map. The zoom indicator of FIG. 3C may be adjusted to increase or decrease the zoom level of map 311. In example aspects, map 311 is configured to increase in zoom level in response to an indication of a user interaction with plus toggle 318 of the zoom indicator 317 and decrease in zoom level in response to an indication of a user interaction with minus toggle 319 of zoom indicator 317.

As shown in FIG. 3C, icon 314 designates a selected area of map 311 and dashed circle 315 represents a geographical range that corresponds to a region on the map that includes the selected area and surrounding areas. The geographical range included in dashed circle 315 of FIG. 3C corresponds to a region that has an area greater than the area of the region corresponding to the geographical range included in dashed circle 305 of FIG. 3A to provide a greater margin of error when selecting an area on a map at a lower zoom level. As shown in FIG. 3C, the determined geographical range is represented by dash circle 315. In other example aspects, the determined geographical range may be represented by different shapes and/or forms (e.g., dashed squares, solid circles, etc.). In other example aspects, an indication of the determined geographical range (e.g., dash circle 315, etc.) is not provided for display on map 311.

Images 316(a)-316(d) are associated with a region on the map within dashed circle 315 are then identified. In other example aspects, additional images associated with the region within dashed circle 315 may be identified. As shown in FIG. 3C, icons for the identified images 316(a)-316(d) are provided for display on map 311. In other example aspects, representations of the identified images associated with the region and/or the dashed circle are not provided for display on map 311. As shown in FIG. 3C, the determined geographical range is represented by dash circle 315. In other example aspects, the determined geographical range may be represented by different shapes and/or forms (e.g., dashed squares, solid circles, etc.).

FIG. 3D illustrates an example interface that provides an image associated with the region of the map of FIG. 3C. In the example of FIG. 3D, an image of the Golden Gate Bridge 316(c) is provided for display on interface 310. In the example of FIG. 3D, image 316(c) is selected from identified images 316(a)-316(d). In other example aspects, different images may be identified in response to a selection of a different area of map 301 at the current zoom level or selection of the same area of map 301 at a different zoom level. In example aspects, the selection process includes identifying a top ranked image from the identified images. The identified images may be ranked from any combination of criterions, including, but not limited to prior user preferences, popularity of the identified images, etc. Furthermore, a top-ranked orientation of the top ranked image may also be identified. In example aspects, the top ranked orientation may be based on the most selected orientation of the top ranked image during a temporal period. In other example aspects, the top-ranked orientation may be based on prior user preferences.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

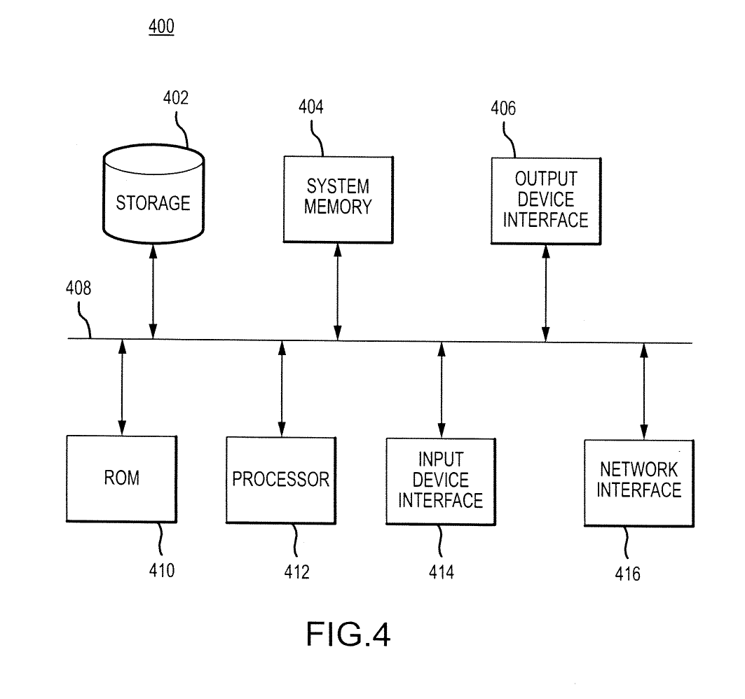

FIG. 4 conceptually illustrates an electronic system with which some implementations of the subject technology are implemented. Electronic system 400 can be a laptop computer, a desktop computer, smartphone, PDA, a tablet computer or any other sort of device 102, 104, and 106. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to an electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for providing an image for display, the method comprising:
determining, by the one or more processors, a zoom level of a map displayed in a user interface;
receiving, at one or more processors, an indication of a selected area on a map displayed in a user interface at the determined zoom level;
determining, by the one or more processors, a geographical range corresponding to a region on the map comprising the selected area and an amount of surrounding area while maintaining the determined zoom level and the displayed map in the user interface, the amount of surrounding area being based on the determined zoom level of the map, such that the region is larger than the selected area and is smaller than and within the map displayed in the user interface;
identifying, by the one or more processors, a set of images associated with the region corresponding to the geographical range, wherein the set of images varies based on the zoom level; and
selecting, by the one or more processors, an image from the identified set of images for display in the user interface.

2. The computer-implemented method of claim 1, wherein the geographical range is a geographical coordinate range and the selected area is greater than a point.

3. (canceled)

4. The computer-implemented method of claim 1, wherein the amount of surrounding area in the region is inversely proportional to a magnitude of the zoom level.

5. The computer-implemented method of claim 1, wherein the selected image is a top ranked image associated with the geographical range.

6. The computer-implemented method of claim 5, further comprising:
selecting a top ranked orientation of the top ranked image; and
displaying the top ranked orientation of the top ranked image is displayed in the user interface.

7. The computer-implemented method of claim 1, wherein the image is at least one of a user-selected canonical image and a panoramic image.

8. (canceled)

9. The computer-implemented method of claim 1, further comprising ranking images in the identified set associated with the geographical range to determine a top-ranked image associated with the geographical range, and
wherein the selecting selects the top ranked image associated with the geographical range for display in the user interface.

10. The computer-implemented method of claim 9, wherein the images in the identified set associated with the geographical range are ranked based on popularity.

11. The computer-implemented method of claim 9, wherein the images in the identified set associated with the geographical range are ranked based on prior user preference.

12. A system for providing an image for display, the system comprising:
one or more processors; and
a machine-readable medium comprising instructions stored therein, which when executed by the processors, cause the processors to perform operations comprising:
determining a zoom level of a map displayed in a user interface;
receiving an indication of a selected area on a map displayed in a user interface at the determined zoom level;
determining a geographical range corresponding to a region on the map comprising the selected area and an amount of surrounding area while maintaining the determined zoom level and the displayed map in the user interface, the amount of surrounding area being based on the determined zoom level of the map, such that the region is larger than the selected area and is smaller than and within the map displayed in the user interface;
identifying a set of images associated with the region corresponding to the geographical range, wherein the set of images varies based on the zoom level; and
selecting an image from the identified set of images for display in the user interface.

13. The system of claim 12, wherein the amount of surrounding area in the region is inversely proportional to the magnitude of the zoom level.

14. The system of claim 12, wherein the geographical range is a geographical coordinate range and the selected area is greater than a point.

15-16. (canceled)

17. The system of claim 12, wherein the operation further comprise ranking images in the identified set associated with the geographical range to determine a top-ranked image associated with the geographical range, and
wherein the selecting selects the top ranked image associated with the geographical range for display in the user interface.

18. The system of claim 12, wherein images in the identified set associated with the geographical range are ranked based on prior user preference.

19. A non-transitory, computer-readable medium comprising instructions stored therein, which when executed by a processor, cause the processor to perform operations comprising:
determining a zoom level of a map displayed in a user interface;
receiving an indication of a selected area on a map displayed in a user interface at the determined zoom level;
determining a geographical range corresponding to a region on the map comprising the selected area and an amount of surrounding area while maintaining the determined zoom level and the displayed map in the user interface, the amount of surrounding area being based on the determined zoom level of the map, such that the region is larger than the selected area and is smaller than and within the map displayed in the user interface;
identifying a set of images associated with the region corresponding to the geographical range, wherein the set of images varies based on the zoom level; and
selecting an image from the identified set of images for display in the user interface.

20. The non-transitory, computer-readable medium of claim 19, wherein the operations further comprises:
ranking images in the identified set associated with the geographical range to determine a top-ranked image associated with the geographical range;
selecting the top ranked image from the ranked images associated with the geographical range; and
selecting a top ranked orientation for the top ranked image for display in the user interface.

21. The computer-implemented method of claim 1, wherein selecting an image from the identified set of images for display in the user interface further comprises:
determining whether the zoom level exceeds a first threshold value and a second threshold value, the first threshold value being less than the second threshold value;
when the zoom level exceeds the first threshold value and does not exceed the second threshold value, selecting an image from the identified set of images that is within a first distance from the selected area; and
when the zoom level does not exceed the first threshold value, selecting an image from the identified set of images that is within a second distance from the selected area, the second distance being greater than the first distance.

22. The computer-implemented method of claim 4, wherein the amount of surrounding area in the region is zero when the zoom level is at a maximum.

23. The computer-implemented method of claim 1, further comprising:
displaying, by the one or more processors, the selected area and the selected image without providing an indication of the amount of surrounding area on the map;
wherein the selected area is enclosed within the amount of surrounding area.

24. The non-transitory, computer-readable medium of claim 19, wherein the selected area is greater than a point.
